(19) United States
(12) Patent Application Publication
(10) Pub. No.: US 2013/0060656 A1
(43) Pub. Date: Mar. 7, 2013

(54) SYSTEM AND METHOD FOR DEFINING TARGET COLOR SPECIFICATIONS

(71) Applicants: Gary N. Bodnar, Springboro, OH (US); Christopher H. Pearson, Springboro, OH (US)

(72) Inventors: Gary N. Bodnar, Springboro, OH (US); Christopher H. Pearson, Springboro, OH (US)

(21) Appl. No.: 13/697,827

(22) PCT Filed: May 17, 2011
(86) PCT No.: PCT/US11/36745

§ 371 Date: Nov. 14, 2012

Related U.S. Application Data
(60) Provisional application No. 61/345,249, filed on May 17, 2010.

(51) Int. Cl. G06Q 30/00

(52) U.S. Cl. 705/26.7

(57) ABSTRACT

A method in a data processing system, a data processing system, and a computer program in computer useable medium generating a numeric specification for one or more target colors that are useful for selecting colors in which a target lightness (Ltarg), a target hue (Htarg) and a target saturation (Ctarg) are determined based upon user inputs.

### BACKGROUND

### Field of the Invention

This invention relates to a method in a data processing system, to a data processing system, and to a computer program in computer useable medium generating a numeric specification for one or more target colors that are useful for selecting colors, for example in recommending paint colors for a consumer.

Many manufacturers of products, for which a significant part of the purchase decision is a determination of color, offer various types of help for their customers in the color picking process, but no common, simple, compelling and generally-accepted process exists, and existing help is not tailored to the unique aspects of the individual situation, nor to the specific goals of the endeavor.

### SUMMARY OF THE INVENTION

One manifestation in of the invention is a method in a data processing system for defining numeric target color specifications for a location. In one embodiment, the method comprises the steps of:

providing a color system having a maximum lightness component (maxL) value and a minimum lightness component (minL) value;

prompting a user to input the amount of light or an approximation thereof at the location in which the target color will be displayed and receiving the user's input;

prompting a user to input a desired change in the perceived size to be caused by the display of the target color in the location and receiving the user's input;

prompting the user to input the desired impact associated with the target color and receiving the user's input;

prompting the user to input the impression the user desires the target color to make at the location in which the color will be displayed and receiving the user's input;

determining a target lightness (Ltarg), a target hue (Htarg) and a target saturation (Ctarg) based upon the user's input.

In one embodiment of the invention, the method comprises the steps of:

providing a database of colors having a maximum lightness component (maxL) value and a minimum lightness component (minL) value;

prompting a user to input or select a lightness value from a first group of values indicative of the amount of light at the location in which the target color will be displayed and receiving the user's input;

prompting a user to input or select a size value from a second group of values indicative of the desired change in the perceived size associated with the target color and receiving the user's input;

prompting the user to input or select an impact value from a third group of values indicative of the desired impact of the target color at the location in which the color will be displayed and receiving the user's input;

prompting the user to input or select an impression from a fourth group of values indicative of the impression the user desires the target color to make at the location in which the color will be displayed and receiving the user's input;

determining a target lightness and a target hue based upon the user's input.

In one embodiment the system will calculate the minimum lightness component (Lmin) value using the following formula:

Lmin=Light*S (F1)

where “Light” is the user inputted amount of light (for example based on a scale from 0 to 1 where 0 represents the most light and 1 represents the least) and S is a darkest lightness component value desired when there is very little light available (Light is 1). Thus, Light serves as a scaling factor which scales the Lmin value between 0 and S. When Light has a value of 1.0, representing a very dark room, S will yield the lightness component value of Lmin (the maximum Lmin). When there is more light in the room, Lmin can be darker than when there is maximum light (Light approaches 0.0) and S will yield Lmin is 0.0 Thus S is constant determined during system set up which reflects the designer's darkest lightness component value when there is very little light.

In another embodiment, the step of determining a target lightness includes the step of calculating a minimum target lightness component (Lmin) based on the equation:

Lmin=minL+Light(S(maxL−minL)) (F2)

where:

minL is the lowest lightness component value or approximation in the color system;

maxL is the highest lightness component value or approximation in the color system;

light is the amount of light in the location to be colored based, for example on a scale from 0 to 1.0 where 0 is a lot of light and 1.0 is not very much light; and

S is defined as above.

In one embodiment, the step of determining the target lightness includes the step of calculating a minimum lightness component based on the equation:

Lmin=minL+(NumAns−Ans)S (F3)

where:

minL is approximately the lowest lightness component value of the colors making up the database;

NumAns is the number of selections from the first group of selections from which the user selected the value indicative of the amount of light;

Ans is the lightness value input by the user; and

S is a scaling factor.

In one embodiment the step of determining the target lightness (Ltarg) may be calculated as follows:

Ltarg=Lmin+Impact(maxL−Lmin)(1.0−R)+Size(maxL−Lmin)(R) (F4)

where:

minL is the lowest lightness component value in the color system or an approximation thereof;

maxL is the highest lightness component value in the colors system or an approximation thereof;

Impact is the users input of the desired visual impact (e.g., on a scale of 0.0 to 1.0 where 0.0 represents high impact and 1.0 represents low visual impact).

Size is the users inputted estimate of the desired change in the perceived size of the location (e.g., for example, using on scale of −1.0 to 1.0 where −1.0 represents the desire for the location to be perceived as small as possible and 1.0 represents the desire for the location to be perceived as large as possible).

R is the percentage of the range of the lightness component values from Lmin to maxL that is reserved for the perceived size adjustment. In the formula F4, the target lightness component value is based on the desired impact and any desired change of size. In general terms, the lighter the color, the lower the impact that color has on the room. Also, a light color can make the room feel larger. If impact was allowed to influence the entire lightness scale, then there would be no lightness left to increase the perceived size of the room. R represents a means to apportion the lightness scale between the influence of Size and Impact.

In a further embodiment, the step of determining the target lightness (Ltarg) may be calculated as follows:

Ltarg=((maxL−Lmin)/Seg)*(Impact+(Size−(NumSize−1)))+Lmin (F5)

where:

maxL is approximately the lightness component value of the lightest color of the colors making up the database,

Seg is the number of segments into which the working lightness component range is divided,

Impact is the impact value selected by the user,

Size is the size value selected by the user,

NumSize is the number of possible selections in the second group of values, and

Seg is the sum total of the number of selections in the first and second groups of values.

One use of the invention applies it to the selection of paint colors for the home. This system is helpful in choosing colors for flooring, fabric, and wall and window coverings and other home decor items for which color is a primary decision criterion. Similarly, systems could be deployed for products beyond home decor where color is a primary decision criterion (e.g., apparel, cosmetics, etc).

In one particular manifestation of the invention, colors selected by the customer independently, and/or as recommended by the color selection system described herein, are displayed in a generic rendering of the room to be painted.

In one embodiment the method is implemented as a web site that can recommend paint colors for a consumer. The system will help the consumer to determine which color they should choose (e.g., from the 1500-2000 colors offered by the paint company). By answering a series of questions, the system determines a target lightness and hue and/or saturation that best fits the users criteria. In a further enhancement the system may incorporate a numerically based color psychology system such as one outlined by Angela Wright (US 2004-0046802 A1) and determine a target psychological group, further narrowing the color choices the user has to make.

### BRIEF DESCRIPTION OF THE DRAWINGS

FIG. 1 is a screen shot of an interactive input screen useful in one embodiment.

FIG. 2 is a collection of computer screen shots used in practicing one embodiment.

### DETAILED DESCRIPTION

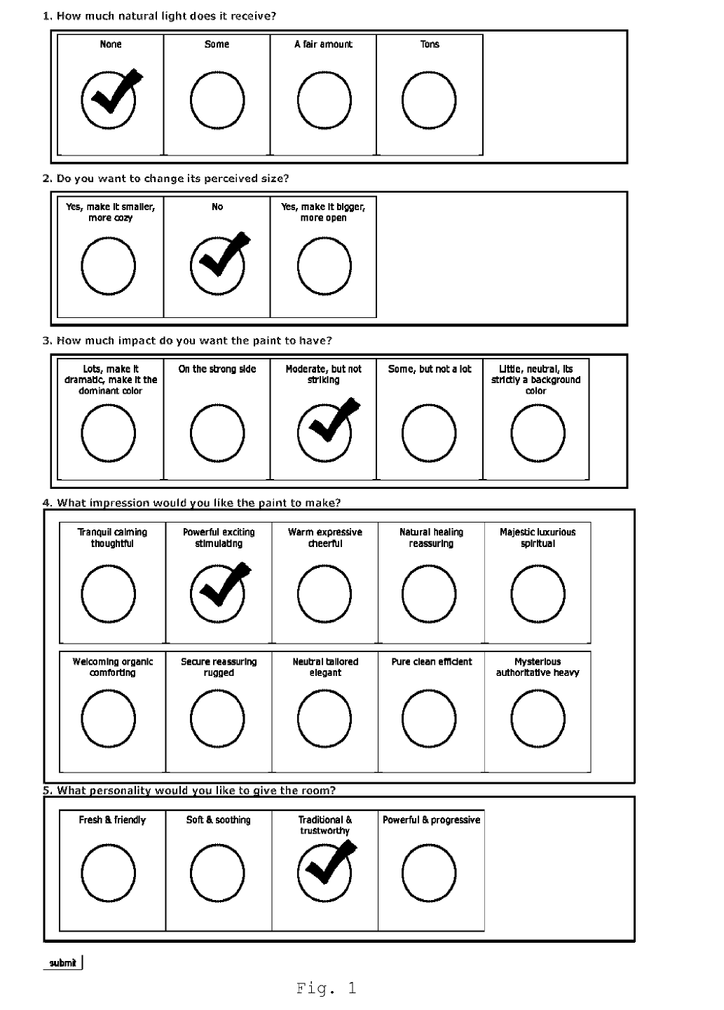

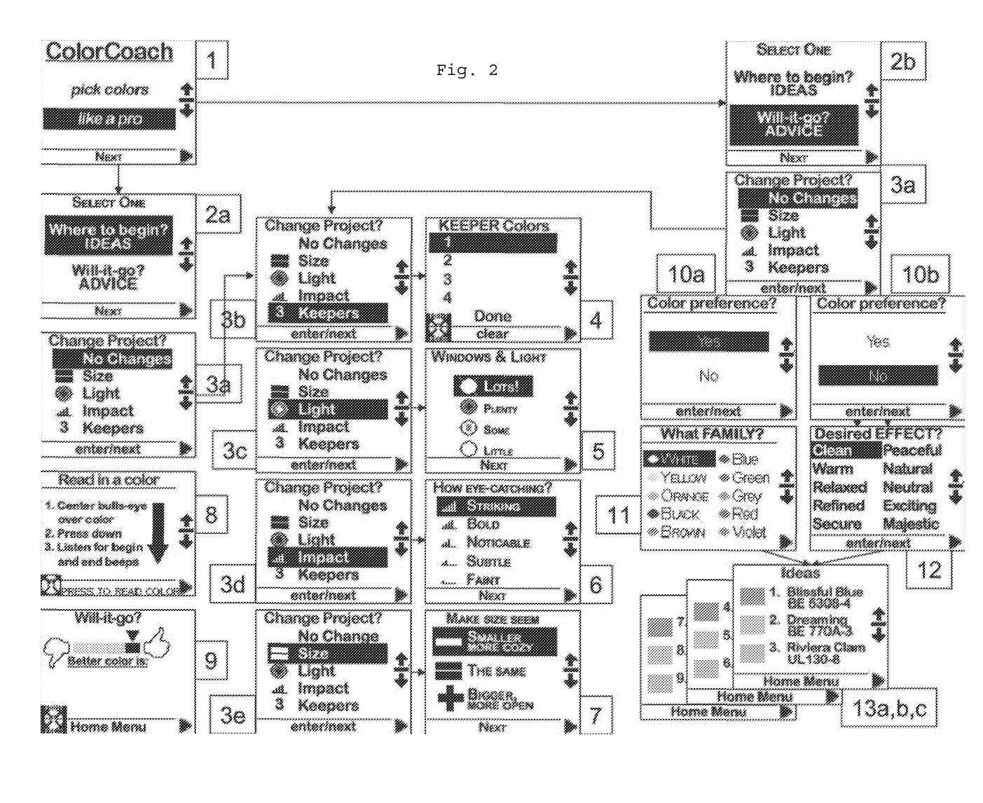

The system is driven by an interactive process in which the user is prompted to input or to select answers to a series of questions that capture the user's goals and desires, and relevant attributes of the space. One example of an interactive session is illustrated generally by the user interface shown as FIG. 1. Another example is shown in FIG. 2.

Once the user's inputs or responses are captured, the system processes the responses, using them to generate a numeric specification for the target colors that can be used to narrow and prioritize the color options. In one embodiment the system can be augmented to execute a set of design rules and descriptions of human reactions to color developed by color psychologists (as disclosed in GB 2 367 731 A published Apr. 10, 2002, filed Oct. 3, 2000 as UK application 0024206.5) into a set of quantitative heuristics that can be used to mathematically rank colors, based on the inputs from the interactive process.

Typically the color options being ranked and/or selected would be defined as a set of colors in which a product is available (e.g., paint colors, carpet colors, etc.), and once ranked, some number (all or a portion) of the highest ranking colors would be displayed to the user as recommendations. Colors are specified in a variety of ways from the amount of particular red, green and blue, or cyan, magenta, yellow and black colorants that makes up the color. Any of the color systems used in the art can be employed in practicing the invention. For example the “lightness component” could be expresses as L* in a CIE system, or B in the HSB color system or L in HSL see: http://en.wikipedia.org/wiki/HSL_and_HSV or Value in the Munsell System. Any color specification system can be used with the disclosed system provided it enables the system to derive a lightness component, a hue component and a chroma or saturation component.

The system is designed to receive inputs or selections from the user quantifying the environment of the location to be colored. These inputs may be generated from the user's answers to inquiries generated by the system. One environmental variable is the amount of light at that location. A designer may qualify the amount of light as “a lot” or “not very much”. The system translates that to a scale (for example a scale from 0 to 1.0 where 0 is a lot of light and 1.0 is not very much light). This information is important, as the amount of light will help determine the minimum lightness value of the color to be used. In general terms, a location with a lot of light can use a darker color than a location with very little light.

In one embodiment the system will calculate the minimum lightness component value using the following formula:

Lmin=Light*S (F1)

where “Light” is the amount of light (for example, based on a relative scale from 0 to 1.0) and S is a scaling factor that determines what the darkest lightness component value desired when there is very little light. In practical terms the value of S is often about 0.5, which represents 50% of the lightness component scale or value range. In the case of paint color for a room, the range of the lightness value component is rarely 0 (perfectly dark, no reflected light) to 1.0 (100% light reflectance) so a modified formula may be used:

Lmin=minL+light(S(maxL−minL) (F2)

where minL and maxL are the minimum and maximum lightness component values or approximations thereof respectively.

In one embodiment, lightness/darkness of a color may be described mathematically by its CIE L*value which can range from 0 to 100 (0 is dark). As discussed herein, in one embodiment, answers or selections made in response to color selection questions are converted into a target lightness component (for example, Q1 below). Similarly, in one embodiment an ideal hue angle is assigned based on the answers to an inquiry regarding color impression; for example, Q4. In still another embodiment an ideal color personality group is assigned based on other answers. The colors may be evaluated by assigning them a score based on how close each is to the target lightness component, target hue, target saturation, and, in one embodiment, the personality group. In one embodiment, the lower the score is, the closer the color is to the ideal/target color. The colors that have the best scores are displayed to the user.

Lmin is the baseline, the darkest lightness component value for a color that should be used, but there are other qualitative considerations that will help define a target lightness component value. One consideration is what affect the color should have on the perceived size of the location where the color will be used. In the case of painting a room, the user may want the paint to make the room seem smaller, more intimate. This would mean that the target lightness component should be darker as darker colors make a room seem smaller. Conversely, if the user wanted the room to be perceived as larger than it is, then the target lightness component should be higher as lighter colors can make a room seem larger. Thus, the user's desire can be represented, for example, on a scale of −1.0 to 1.0 where −1.0 represents the desire for the location to be perceived as small as possible and 1.0 represents the desire for the location to be perceived as large as possible. A value of 0.0 on the scale means that the user has no desire to change the perceived size of the location.

Another consideration for determining the lightness component target value is the users desire for the impact of that color on the location in which it is used. The impact can simply mean, how noticeable that color is. In the case of painting a room, light colors with low saturation have less visible impact than dark saturated colors. In one embodiment, the system represents the users desire on a scale of 0.0 to 1.0 where 0.0 represents high impact and 1.0 represents low visual impact.

If the desired impact was used alone, then the target lightness value (Ltarg) can be calculated using the following formula:

Ltarg=Lmin+Impact(maxL−Lmin) (F5)

The formula above scales the range of lightness component values from Lmin to maxL based on the desired impact value (for example, 0.0 to 1.0). If there is a desire to take into account the effect of changing the location's perceived size a more complex formula can be used:

Ltarg=Lmin+imact(maxL−Lmin)(1.0−R)+size(maxL−Lmin)(R) (F4)

where R represents the percentage of the range of the lightness component values from Lmin to maxL that is reserved for the perceived size adjustment. While this can be any percentage from 0% to 100%, in this embodiment a value 10% (0.10) is used.

The target lightness component value (Ltarg) is helpful when narrowing down possible colors to use in a location, but the system can further define the target color by determining a target hue (Htarg) and/or target saturation (Ctarg). In one embodiment, the system uses one of two methods for determining a target hue component value. Either by asking directly, what hue family the user desires for the location or by asking the user to choose from a set of impressions.

Impression adjectives have been used by designers and color psychologists to ascribe mood or affect of a given color. Since each answer is a general color, color coordinates that are consistent with that general color can be assigned as the target. For instance many color psychologists associate the color red with power and excitement. Thus, if the user wants the location to have a powerful impression, then they should use a red color in that location. These color families can easily be specified as a given hue angle component value. The system refers to this target hue component value as Htarg. The colors, gray white and black however do not have a particular hue angle associated with them and as such need special treatment. If the user indicates a desire for gray, white or black, the more appropriate color specification component is saturation or chroma. By definition, gray has zero saturation. White does as well, but white also has a high lightness component value so when white is desired, it will override the lightness component target value and make that be a high value. Similarly for black which has a zero saturation component value and a low lightness component value. Thus, there is a need for a saturation component target value Ctarg. In the case of gray white and black, that value will be zero.

At this point the system has a target lightness component value (Ltarg) and a target hue angle (Htarg) or saturation component value (C targ). Using these values the system can rank an entire database of colors where colors with very similar hue, saturation and lightness are ranked higher than colors that are dissimilar and those highly ranked colors would be recommended to the user as colors that meet their desire for the location.

The target color specification can be further defined by the desired personality for the location. Color psychologists have long associated personalities to groups of colors. (See Beginner's Guide to Colour Psychology by Angela Wright. Gazelle Distribution Trade, Dec. 1, 1998) By asking the user to define the desired personality of the location, a target group value can be assigned. Using a numerically based color psychology system, colors can be assigned to a group and colors within that psychology group that meet the other Htarg, Ctarg and Ltarg criteria will be recommended by the system.

In order to test a given color or to rank a database of colors, the system may determine an acceptable difference from the target color component values. This acceptable distance will depend on many factors including the color system being employed and the desires of the system designer. This is similar to any pass/fail quality control system. Said system will have the ability to say whether something is within an acceptable bounds or not, but those bounds have to be determined by what is being controlled.

Although many configurations are possible, in one embodiment the system is deployed on a platform with computational capabilities such as over the internet, locally on a PC, in a kiosk at a retail location, on a smart phone or a handheld device. The system could also be implemented through an intermediary such as a text message, email, or via telephone.

In one embodiment, the user answers a series of questions by making entries into a form on a web page. After collecting the necessary answers, the computer ranks the available colors based on the input. The computer translates the answers provided by the user into a set of criteria including a target lightness component and hue that characterize the target color. In addition to lightness component and hue, other criteria may also be incorporated into the analysis. Those criteria include personality group, and for some colors, their chroma (intensity). Whatever colors are offered as options (a paint palette, a set of carpet colors, makeup colors, etc) (each collection being an example of a color database) may be “graded” individually, for example, based on how close they are to the ideal/target values and a set of recommendations is reported to the user.

To generate or give feedback on a color, the system defines color specifications that meet the goals of the user. Once those goals are determined, then individual or collections of colors can be compared to the goals. The system can make color suggestions that best achieve those goals or test a color to see if it achieves the goals. The invention takes the answers to questions about the environment in which the color is to be used, the desires of the user and the purpose of the color to generate numerical color specifications. The system creates a numeric specification for a target color based on the value of answers to subjective questions about the project or space to be colored. One preferred embodiment of the invention would be a web site that can recommend paint colors for a consumer. The system will help the consumer to determine which color they should choose from the colors available for the product.

The following will detail the questions and process in this preferred embodiment that yield a target color specification. In a particular embodiment the process may employ the CIE L*a*b* color system and it's corresponding components, C* for Chroma and H* for Hue Angle.

The first question is this embodiment is used to determine the target for minimum lightness.
How much light does the room receive? (Q-1)

The answer can range from a lot of light to no light at all. In the embodiment, four choices are given and the user must pick one. Alternatively a relative scale may be used or a slider bar may be used to input the amount of light as discussed herein.

1. None

2. Some

3. A fair amount

4. A high amount

The value of the answer is it's number. The target minimum lightness component is calculated:

Lmin=minL+(numAns−Ans)S (F3)

where:

minL is the approximate lowest lightness component target the system will use;

numAns is the number of answers, in this case four;

Ans is the number of the answer chosen by the user;

S is the scaling factor

The constant minL can be set as the darkest color in a given paint color database. In this embodiment a value of 40 is used. The constant S is the multiplier applied to the inverse of the answer, in the case of this embodiment; a value of 10 is used. In general terms what this means is Lmin is lower (darker) when the project receives tons of light and is higher (lighter) when the project receives no light. In general, designers don't want to put a really dark color in a dark room and this question makes sure that the target lightness is not too dark.

The next two questions help determine the target lightness component using their answers along with the Lmin value calculated from the previous question. Those questions and answers are:

Do you want to change its perceived size? (Q-2)

1. Yes, make it smaller, more cozy

2. No

3. Yes, make it bigger, more open

How much impact do you want the paint to have? (Q-3)

1. Strong, dramatic, the dominant color

2. On the strong side

3. Moderate, but not striking

4. Some, but not a lot

5. Little, neutral, its strictly a background color

The target L is then calculated as follows:

Ltarg=((maxL−Lmin)/Seg)*(Impact+(size−(numSize−1)))+Lmin (F5)

where:

maxL is the maximum target lightness component value,

Seg is the number of segments the working lightness component range is divided up into,

Impact is the Impact selected by the user,

Size is the Size selected by the user,

numSize is the number of possible answers for the size value inquiry

The constant maxL is the lightness component value of the lightest color in a given paint color database. In one embodiment, maxL is 90.

In this embodiment, the constant Seg is 6. It is calculated as the number of possible answers to the Impact inquiry or prompt plus 1. The plus 1 takes into account size prompt. question. Thus, the target lightness component is somewhere between the calculated Lmin and maxL. Designers say that a darker color will have more impact than a lighter color. But the target L will be adjusted either up or down depending on the answer to the size inquiry or prompt.

The next question in this embodiment is used to determine either the target hue or the target chroma. The prompt may be:

What impression would you like the paint to make? (Q-4)

In one embodiment the user has 10 choices such as:

1. Tranquil calming thoughtful

2. Powerful exciting stimulating

3. Warm expressive cheerful

4. Natural healing reassuring

5. Majestic luxurious spiritual

6. Welcoming organic comforting

7. Secure reassuring rugged

8. Neutral tailored elegant

9. Pure clean efficient

10. Mysterious authoritative heavy

Each answer aligns with a generic color and these impression adjectives have been used by designers and color psychologists to ascribe mood or affect of a given color. Since each answer is a general color, color coordinates that are consistent with that general color can be assigned as the target. In this embodiment, here are the targets assigned to each answer:
1. Tranquil calming thoughtful—blue hues. Htarg=234 degrees.
2. Powerful exciting stimulating—red hues. Htarg=11 degrees.
3. Warm expressive cheerful—yellow hues. Htarg=87 degrees. Because yellow colors are light if the Ltarg value is less than yellowThreshL, then Ltarg=midYellowL. In this embodiment, yellowThreshL is a value of 60 and midYellowL is a value of 70.
4. Natural healing reassuring—green hues. Htarg=144 degrees.
5. Majestic luxurious spiritual—violet hues. Htarg=307 degrees.
6. Welcoming organic comforting—orange hues. Htarg=55 degrees. Because orange colors are light, if the Ltarg value is less then orangeThreshL then Ltarg=midOrangeL. In this embodiment, orangeThreshL is a value of 60 and midOrangeL is a value of 70.
7. Secure reassuring rugged—brown hues. Htarg=55 degrees. Because brown colors are dark, if the Ltarg value is greater then brownThreshL then Ltarg=midBrownL. In this embodiment, brownThreshL is a value of 60 and midBrownL is a value of 40.
8. Neutral tailored elegant—grays. Ctarg=0. Since gray is the absence of color, there is no hue angle that describes gray, instead, gray is defined as having a very low chroma. So in the case of grays whites and blacks, the target will be a chroma of 0.
9. Pure clean efficient—whites. Ctarg=0. Since whites are very light, Ltarg is changed to maxL.
10. Mysterious authoritative heavy—blacks. Ctarg=0. Since blacks are very dark, Ltarg is changed to minL.

In one embodiment is used to identify a target psychological group. Using the teachings in the Wright patent application, colors are assigned 1 of 4 different psychological groups and each group is assigned a number from 1 to 4. The question directly relates to the psychological grouping:

What personality would you like the paint to create? (Q-5)

1. Fresh & friendly

2. Soft & soothing

3. Traditional & trustworthy

4. Powerful & progressive

The Gtarg is the value of the answer to this question.

Note that in this embodiment, many of the values used to calculate the targets are integers directly related to the number of answers shown to the user. The system is not limited to integer input. For instance, the answer to the “How much light does the room receive?” could just as easily be any real number and input not as an integer choice, but by a software slider that the user adjusts. Even the answer to the “What impression would you like the paint to make?” question could be a continuum between some number of color impression adjectives and the system interpolates between those set points to come up with target color coordinates.

From this point forward the system can assess a given color's fitness to the users goals. In the case of a paint selection web site, the system can score every color in a given paint database and recommend those colors that score the best. In this embodiment, a color difference similar to a CIE color difference (Δ−E) can be calculated as follows:

Diff=ΔCH+ΔL+ΔG (F6)

where:

ΔCH=|Htarg−H*| or ΔCH=|Ctarg−C*| in the case of gray, white or black.

ΔL=|Ltarg−L|

ΔG=0 if Gtarg is the same as the color's group else ΔG=25

In one embodiment, Diff is calculated for each color in a given paint database and colors with a difference below DiffThresh are recommended to the user. This embodiment uses a DiffThresh value of 20.

In a handheld color measurement device embodiment, the user can define their goals and then measure a color to see if it fits the goal, e.g. Diff is less than some threshold.

Recommendations may be provided simply as a list of name and/or stock numbers, representations of the colors may be displayed on a screen, the colors may be shown visually in the intended environment (e.g., by showing a room with walls painted the recommended color), or a computer-generated visualization of the colors could be created from an image provided by the user.

### Implementation of Digital Design Process on a Handheld Device

One embodiment of this methodology is embedded in a handheld device. The user would supply information about their project by interacting with this device, using it to measure colors of interest when prompted. One implementation would be the sequence of screens as shown in FIG. 2.

When the user powers up the device, a start up “splash” screen [1] would appear for branding and name recognition. The user would press the “Next” button to begin the process. The device would then prompt the user to select one of the two forms of help (tools) that the device can offer [2a, 2b]. The user would use the pushbuttons to select the desired tool, and press the “Next” button to proceed.

The user is then presented with a “Set Design Factors” screen which lists design factors and their current status/setting[3a, 3b, 3c, 3d, 3e]. If there is no need to change any of the settings, the user would leave the “No changes” menu item selected [3a], and press the “Next” button to proceed. Otherwise, if the user wants to change one of the Design Factors, they would use the pushbuttons to highlight whichever of the 4 factors that they wish to update, and press the “Next” button to proceed.

If the user selects “Keeper Colors” [3b], the Keeper Colors screen would appear [4]. At this point the user could select any of the 4 memory locations in the device and then use the device to read a color or scan into that memory location. This process might be used to record colors that will not change. In other words, they are “keepers.” For example, the user's project may not include replacing the sofa. Recording the sofa as a Keeper Color enables the device to determine which Color Group is predominate, and therefore enables it to determine which new colors will harmonize with the existing colors. When finished, the user would use the buttons to highlight “Done” then press the “Next” button to return to the Set Design Factors screen [3b].

If the user selects “Natural Light” [3c], the Natural Light screen [5], prompts them with a menu of choices that describe various levels of natural light. For example, See Q-1 above. They would select the amount of natural light in their room, and then press the “Next” button to proceed back to the Set Design Factors screen [3c].

If the user selects “Color Impact” [3d], the Color Impact screen [6] prompts them with a range of choices about the desired impact of the new color (e.g., bold, subdued). For example, See Q-3 above. They would select the level of impact they prefer, and then press the “Next” button to proceed back to the Set Design Factors screen [3d].

If the user selects the “Spaciousness” screen [3e], the Spaciousness screen [7] enables them to specify whether they want to change the perceived size of the space (e.g., make the space seem smaller and more cozy or bigger and more expansive). For example, See Q-2 above. After making their choice, they press the “Next” button to return to the Set Design Factors screen [3e].

Once all of the design factors have been satisfactorily set and the “No Changes” menu item is selected [3a], the user presses the “Next” button to proceed to use the tool that they chose earlier [2a, 2b]. If the user chose the “Will-it-go? Advice” tool [2a], the device would prompt the user to read in a color they'd like advice about [8]. Once the user reads a color with the device, it reports how well the color they read in will fit into their design [9] as define by the Design Factors settings. If the user chose the “Where to begin? Ideas” tool [2b], the device would then display a screen asking the user if they have a preferred hue (e.g., the blue family) [10a, 10b]. Using the pushbuttons, either the “Yes” [10a] or “No” [10b] answer would be selected. If the user selects “Yes”, the device will display a list of color families from which to choose [11]. The user would select the desired family and press the “Next” button. If the user selects “No”, the device will display the “Desired Effect” screen [12], which displays a list the environmental characteristics that each color family creates. The user would select the desired effect and press the “Next” button.

Once either a Color Family or a Desired Effect has been selected in this embodiment, the device will display a list of 3 color ideas [13a] that have been selected from the appropriate color family or effect family and which accommodate the Design Factors. Pressing the down arrow button allows the user to display additional color ideas [13b, 13c].

In one manifestation of the invention, one or more generic room sketches are created which can be easily recolored. For example, colors can be selected and displayed for individual walls, trim, accents, etc. The sketches are preferably kept simple to allow the viewer to see the colors in combination or side-by-side in approximately the proportions in which they will appear in the finished room, but without the software complexities involved in masking or providing a more photographic simulation. An example of one such display is provided in Exhibit 3.

As shown in Exhibit 3, in one embodiment, the customer's responses to the questions discussed above are displayed in a side menu. In one embodiment, the room sketch generally represents the amount of lighting the customer perceives for the room. In one embodiment, a color palette is created based upon the customer's responses and/or the customer's independent selections. By dragging and dropping the colors to various locations within the generic room sketch, the customer can readily evaluate the effect of various color combinations.

Having described the invention in detail and by reference to specific embodiments thereof it will be apparent that numerous variations and modifications are possible without departing from the spirit and scope of the following claims.

What is claimed:

1. A method in a data processing system for defining numeric target color specifications for a location, the method comprising the steps of:
providing a color system having a maximum lightness component (maxL) value and a minimum lightness component (minL) value;
prompting a user to input the amount of light at the location in which the target color will be displayed and receiving the user's input;
prompting a user to input a desired change in the perceived size to be caused by the display of the target color in the location and receiving the user's input;
prompting the user to input the user's perception of the impact of the target color at the location in which the color will be displayed and receiving the user's input;
prompting the user to input the user's perception of the impression the user desires the target color to make at the location in which the color will be displayed and receiving the user's input;
determining a target lightness (Ltarg), a target hue (Htarg) and a target saturation (Ctarg) based upon the user's input.

2. The method of claim 1 wherein the step of determining a target lightness includes the step of calculating a minimum target lightness component (Lmin) based on the equation:
Lmin=minL+Light(S(maxL−minL))
where:
minL is the lowest lightness component value in the color system;
maxL is the highest lightness component value in the color system;
Light is user input value based on the amount of light in the location to be colored;
S is the darkest lightness component value desired when there is very little light.

3. The method of claim 2 wherein the step of determining the target lightness (Ltarg) is calculated as follows:
Ltarg=Lmin+Impact(maxL−Lmin)(1.0−R)+Size(maxL−Lmin)(R)
where:
minL is the lowest lightness component value in the color system or an approximation thereof;
maxL is the highest lightness component value in the colors system or an approximation thereof;
Impact is the user's input objective for the visual impact of the target color.
Size is the user's input objective to change in the perceived size of the location produced by the target color.
R is the percentage(0-100%) of the range of the lightness component values from Lmin to maxL that is reserved for the perceived size adjustment.

4. A method in a data processing system for defining numeric target color specifications for a location, the method comprising the steps of:
providing a database of colors having a maximum lightness component (maxL) value and a minimum lightness component (minL) value;
prompting a user to input a lightness value from a first group of values indicative of the amount of light at the location in which the target color will be displayed and receiving the user's input;
prompting a user to input a size value from a second group of values indicative of the desired change in the perceived size of the location associated with the target color and receiving the user's input;
prompting the user to input an impact value from a third group of values indicative of the desired impact of the target color at the location in which the color will be displayed and receiving the user's input;
prompting the user to input an impression from a fourth group of values indicative of the impression the user desires the target color to make at the location in which the color will be displayed and receiving the user's input;
determining a target lightness and a target hue based upon the user's input.

5. The method of claim 4 wherein the step of determining a target lightness includes the step of calculating a minimum target lightness component based on the equation:
Lmin=minL+(NumAns−Ans)S
where:
minL is approximately the lowest lightness component value of the colors making up the database;
NumAns is the number of inputs from the first group of selections from which the user inputted the value indicative of the amount of light;
Ans is the lightness value inputted by the user; and
S is a scaling factor.

6. The method of claim 5 wherein the step of determining the target lightness (Ltarg) is calculated as follows:
Ltarg=((maxL−Lmin)/Seg)*(Impact+(Size−(NumSize−1)))+Lmin
where:
maxL is approximately the lightness component value of the lightest color of the colors making up the database.
Seg is the number of segments into which the working lightness component range is divided,
Impact is the impact value inputted by the user,
Size is the size value inputted by the user,
NumSize is the number of selections in the second group of values, and
Seg is the sum total of the number of selections in the first and second groups of values.

7. The method of claim 6 wherein the step of prompting the user to input a value indicative of the impression (Htarg or Ctarg) includes the step of providing a database correlating each selection in the fourth group with a hue angle.

8. The method of claim 7 wherein the method additionally includes a step of selecting a color for the location using the Htarg and the Ltarg values.

9. The method of claim 7 wherein the method additionally includes the step of prompting the user to input the psychological impression the user desires the color to make by prompting the user to input an impression from a fifth group of values and receiving the user's input and using that input to define a target group value (Gtarg).

10. The method of claim 8 wherein the method additionally includes using Gtarg in combination with Htarg and Ltarg as the target color specifications.

11. The method of claim 6 wherein maxL is about 90, and minL is about 40.

12. The method of claim 4 wherein the first group of values is selected from the group consisting of (1) none, (2) some, (3) a fair amount, and (4) a very large amount.

13. The method of claim 4 wherein the second group of values is selected from the group consisting of (1) smaller, (2) no change, and (3) bigger.

14. The method of claim 4 wherein the third group of values is selected from the group consisting of (1) dramatic, (2) strong, (3) moderate, (4) some but limited, and (5) little or merely background.

15. The method of claim 4 wherein the fourth group of values is selected from the group consisting of (1) blue—Htarg about 234°, (2) red—Htarg about 11°, (3) yellow—Htarg about 87°, (4) green—Htarg about 144°, (5) violet—Htarg about 307°, (6) orange—Htarg about 60°, (7) brown—about 55°, (8) gray—Ctarg=0, (9) white—Ctarg=0; Ltarg=maxL, and (10) black—Ctarg=0; Ltarg=minL.

16. The method of claim 4 wherein the fifth group of values is selected from the group consisting of (1) fresh or friendly, (2) soft or soothing, (3) traditional or trustworthy, and (4) powerful or progressive.

17. A data processing system for providing numeric target color specifications for a location, the data processing system comprising a processor and a memory device coupled to the processor, wherein the memory contains instructions and a database of color values such that when the instructions are executed by the processor they cause the processor to:
provide a database of colors having a maximum lightness component (maxL) value and a minimum lightness component (minL) value;
prompt a user to input a lightness value from a first group of values indicative of the amount of light at the location in which the target color will be displayed and receive the user's input;
prompt a user to input a size value from a second group of values indicative of the desired change in the perceived size of the location associated with the target color and receiving the user's input;
prompt the user to input an impact value from a third group of values indicative of the desired impact of the target color in the location in which the color will be displayed and receive the user's input;
prompt the user to input an impression from a fourth group of values indicative of the impression the user desires the target color to make at the location in which the color will be displayed and receive the user's input; and
determine a target lightness and a target hue based upon the user's input.

18. The data processing system of claim 17 wherein the instructions are provided to the memory device by means of a web page.

19. A computer program product comprising a computer-useable medium having a computer readable program wherein the computer readable program, when executed on a computing device, causes the computing device to define numeric target color specifications for a location by providing a database of colors having a maximum lightness component (maxL) value and a minimum lightness component (minL) value;
prompting a user to input a lightness value from a first group of values indicative of the amount of light at the location in which the target color will be displayed and receiving the user's input;
prompting a user to input a size value from a second group of values indicative of the desired change in the perceived size of the location associated with the target color and receiving the user's input;
prompting the user to input an impact value from a third group of values indicative of the desired impact of the target color in the location in which the color will be displayed and receiving the user's input;
prompting the user to input an impression from a fourth group of values indicative of the impression the user desires the target color to make at the location in which the color will be displayed and receiving the user's input;
determining a target lightness and a target hue based upon the user's input.

20. A method for selecting a color comprising the steps of:
providing on a computer device a series of color selection questions based on design rules and human reactions to color that capture a user's goals and desires, and relevant attributes of the space for which the color is selected,
providing answers to the a series of color selection questions by, for example, making entries into a form provided on the computer device,
converting the answers to the color selection questions into a set of color target values, for example, value selected from the group consisting of a target lightness component value, an ideal hue angle, a color personality group, or a combination of one or more thereof,
calculating a score for all or a subgroup of available colors based on how close the color is to the color target values,
and showing a selection of the colors having scores closest to the color target values to the user from which selection of colors the user can make a color selection.
